(19) United States
(12) Patent Application Publication
(10) Pub. No.: US 2011/0214004 A1
(43) Pub. Date: Sep. 1, 2011

(54) PACKAGED CIRCUIT

(76) Inventors: Yi-Le Yang, Hsinchu City (TW); Chun-Liang Chen, Hsinchu City (TW); Yu-Cheng Lo, Taipei City (TW)

(21) Appl. No.: 12/731,101

(22) Filed: Mar. 24, 2010

(30) Foreign Application Priority Data
Mar. 1, 2010 (TW) 099105872

(51) Int. Cl. G06F 1/04

(52) U.S. Cl. 713/500; 713/600

(57) ABSTRACT

A packaged circuit includes an internal circuit, an embedded clock generator, a plurality of multi-function pins and a control pad. The embedded clock generator is for generating an internal clock. The pins include a clock output pin and a clock input pin. The clock output pin outputs the internal clock generated by the embedded clock generator. The clock input pin is for receiving an external clock. The control pad receives a control signal to determine whether the internal circuit utilizes a system clock according to the internal clock generated by the embedded clock generator or the external clock received by the clock input pin.

### BACKGROUND OF THE INVENTION

1. Field of the Invention

The present invention relates to a packaged circuit, and more particularly, to a packaged circuit with an internal clock.

2. Description of the Prior Art

A clock circuit requires an external element (e.g., a crystal resonator or a ceramic resonator) to provide a high-quality resonator that generates a low-noise clock signal. This extra external element, however, also means extra pins and an increased package area, leading to an increase in packaging effort and cost.

Please refer to FIG. 1, which is a system diagram of a conventional packaged circuit 100 with an embedded clock generator. The packaged circuit 100 has an embedded clock generator 101, a frequency divider 102 and an internal circuit 103. In a practical implementation, an external calibration element 112 is coupled to the embedded clock generator 101 for calibrating an embedded clock CLK_OSC generated by the embedded clock generator 101. The frequency divider 102 thereby divides frequency of the internal clock CLK_OSC to output a system clock CLK_SYS to the internal circuit 103, and then an external interface 114 is coupled to the internal circuit 103 to perform following signal processing. Since an on-chip resonator, which is embedded within the chip, is utilized instead of an external element, a quality of the clock CLK_OSC generated by the embedded clock generator 101 cannot be assured. Even if the external calibration element 112 is utilized, it is still difficult to rule out a cause of error when debugging.

For general market requirements, how to reduce the amount of time consumed for debugging and enhancing the clock quality still remains a vital issue in this field.

### SUMMARY OF THE INVENTION

In light of this, the present invention provides a packaged circuit with an internal clock. The packaged circuit utilizes multi-function pins, and is capable of measuring and improving (or calibrating) a quality of the internal clock within the packaged circuit easily and quickly, providing the internal clock to other external circuits, and reducing the bill of material (BOM) cost. It is also capable of adopting the internal clock or the external clock as a system clock of the packaged clock according to a user's requirement.

According to an embodiment of the present invention, a packaged circuit includes an internal circuit, an embedded clock generator, a plurality of multi-function pins and a control pad. The embedded clock generator is for generating an internal clock. The pins include a clock output pin and a clock input pin. The clock output pin outputs the internal clock generated by the embedded clock generator. The clock input pin is for receiving an external clock. The control pad receives a control signal to determine whether the internal circuit utilizes a system clock according to the internal clock generated by the embedded clock generator or according to the external clock received by the clock input pin.

According to another embodiment of the present invention, a packaged circuit includes an internal circuit, an embedded clock generator and a plurality of multi-function pins. The embedded clock generator generates an internal clock. The plurality of multi-function pins includes a clock output pin and a clock input pin. The clock output pin outputs the internal clock generated by the embedded clock generator. The clock input pin receives an external clock. The internal circuit calibrates the internal clock generated by the embedded clock generator according to the external clock received from the clock input pin.

According to another embodiment of the present invention, a packaged circuit includes an internal circuit, an embedded clock generator and a plurality of multi-function pins. The embedded clock generator generates an internal clock. The plurality of multi-function pins includes a clock output pin and a clock input pin. The clock output pin outputs the internal clock generated by the embedded clock generator. The clock input pin is directly connected to the clock output pin via an electrical connection. The internal circuit utilizes the internal clock received from the clock input pin as a system clock.

According to another embodiment of the present invention, a packaged circuit includes an internal circuit, an embedded clock generator and a plurality of multi-function pins. The embedded clock generator generates an internal clock. The plurality of multi-function pins includes a clock output pin and a clock input pin. The clock output pin outputs the internal clock generated by the embedded clock generator. The clock input pin is directly connected to the clock output pin via an electrical connection. The clock output pin is directly connected to an external circuit via an electrical connection and the internal clock serves as a clock source of the external circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a system diagram of a conventional packaged circuit with an embedded clock generator.

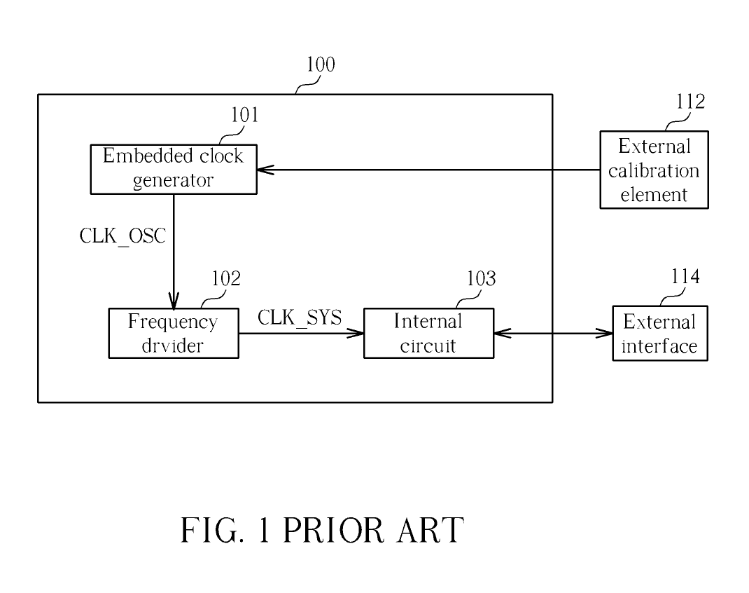

FIG. 2 is a system diagram of a packaged circuit with an embedded clock generator according to an embodiment of the present invention.

FIG. 3 is a system diagram of a packaged circuit with an embedded clock generator according to another embodiment of the present invention.

FIG. 4 is a system diagram of a packaged circuit with an embedded clock generator according to yet another embodiment of the present invention.

FIG. 5 is a diagram of setting a packaged circuit according to an embodiment of the present invention.

FIG. 6 is a diagram of setting a packaged circuit according to another embodiment of the present invention.

FIG. 7 is a diagram of setting a packaged circuit according to yet another embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

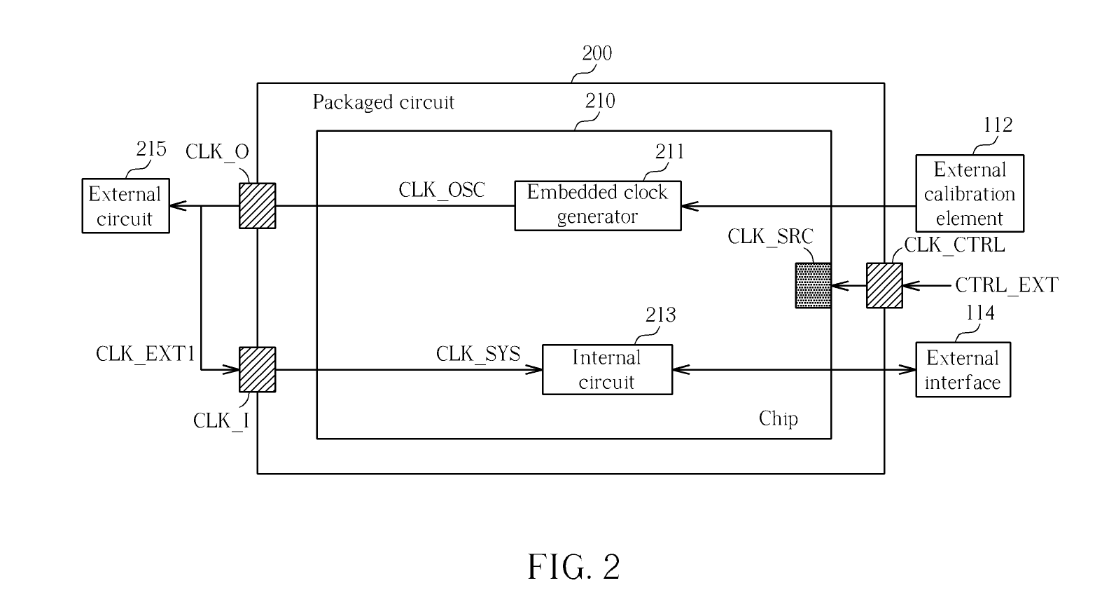

Please refer to FIG. 2, which is a system diagram of a packaged circuit 200 with an embedded clock generator according to an embodiment of the present invention. The packaged circuit 200 includes a chip 210, a clock output pin CLK_O, a clock input pin CLK_I and a control pin CLK_CTRL, wherein the chip 210 includes an internal circuit 213, an embedded clock generator 211 and a control pad CLK_SRC. The embedded clock generator 211 is for generating an internal clock CLK_OSC, and can be realized by an LC oscillator, an RC oscillator or a phase-delay oscillator in a practical implementation. The clock output pin CLK_O outputs the internal CLK_OSC generated by the embedded clock generator 211 to an external circuit 215, and the clock input pin CLK_I is for receiving an external clock. The control pin CLK_CTRL is directly connected to the control pad CLK_SRC via an electrical coupling (e.g., a bonding wire), and the control pad CLK_SRC receives a control signal CTRL_EXT via the control pin CLK_CTR to determine whether the internal circuit 213 utilizes the internal clock CLK_OSC generated by the embedded clock generator 211 or an external clock CLK_EXT1 received from the clock input pin CLK_I as a system clock CLK_SYS L. The control signal CTRL_EXT is coupled to an external ground voltage (or an external supply voltage) to select the internal clock CLK_OSC generated by the embedded clock generator 211 as the system clock CLK_SYS.

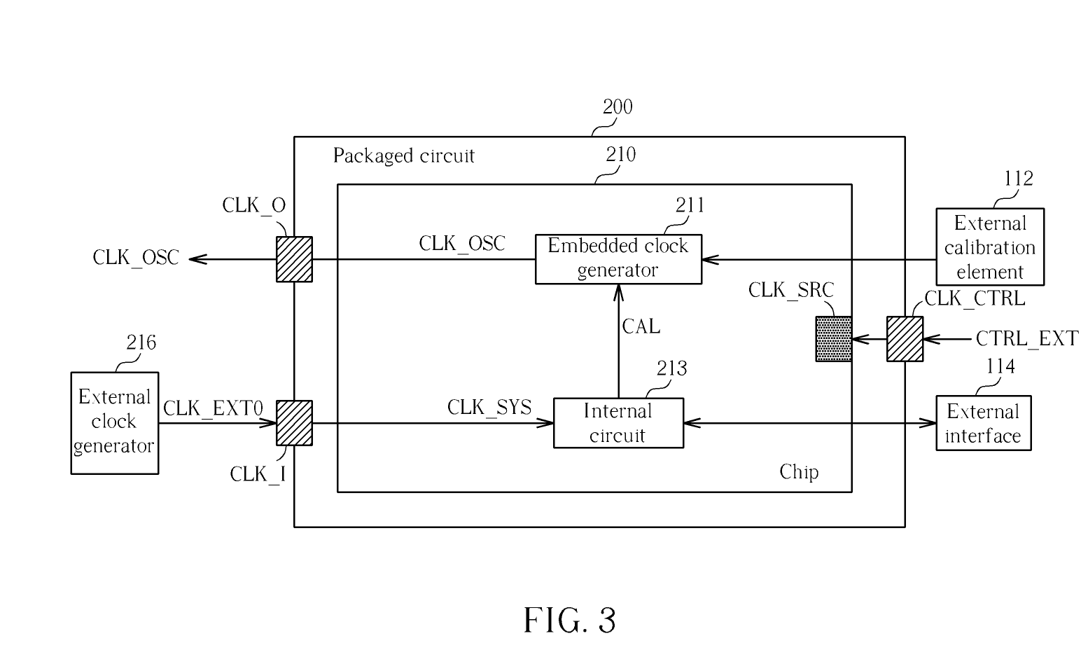

Compared with conventional packaged circuits, the packaged circuit 200 provided in the present invention can further output the internal clock CLK_OSC generated by the embedded clock generator 211 for signal quality measurement or utilization of other circuits, thereby reducing a bill of material (BOM) cost. In addition, when a measurement result of the internal clock CLK_OSC indicates that the signal quality is poor, an external clock generator can be utilized to calibrate the embedded clock generator 211. Please refer to FIG. 3, which is a system diagram of a packaged circuit 200 with an embedded clock generator according to another embodiment of the present invention. Compared with FIG. 2, the clock output pin CLK_O of the packaged circuit 200 in FIG. 3 is for measuring the signal quality of the internal clock CLK_OSC, and the clock input pin CLK_I is for receiving a clock CLK_EXT0 generated by an external clock generator 216. The clock CLK_EXT0 is thereby outputted to the internal circuit 213 to be processed, and the internal circuit 214 then refers to the clock CLK_EXT0 to generate a calibration signal CAL to the embedded clock generator 211 for calibration, so as to improve the signal quality of the internal clock CLK_OSC.

With the help of the clock input pin CLK_I and the clock CLK_EXT0 generated by the external clock generator 216, the packaged circuit 200 can quickly perform a function and module test at the packaging stage, and perform initial clock calibration for the embedded clock generator 211. This initial calibration can be simultaneously combined with the function of on-line calibration, so as to enhance fault coverage in mass production test.

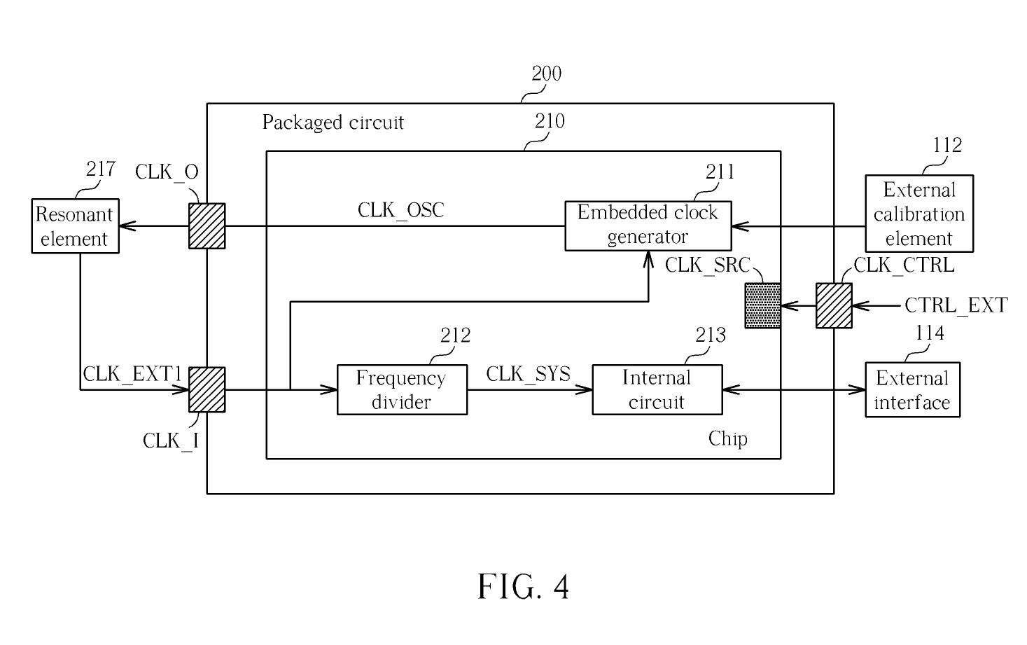

As well as utilizing resonant structures within a chip, the packaged circuit provided in the present invention can also adopt conventional external resonant elements to generate clock signals. Please refer to FIG. 4, which is a system diagram of a packaged circuit 200 with an embedded clock generator according to yet another embodiment of the present invention. Compared with FIG. 2, the internal clock CLK_OSC generated by the embedded clock generator 211 in FIG. 4 is not transmitted directly to the clock input pin CLK_I via an electrical connection but rather via an external resonant element 217 (e.g., a ceramic resonance or a ceramic resonance), and the resonant element 217 thereby outputs a clock CLK_EXT1 to the embedded clock generator 211 via the clock input pin CLK_I so as to form a closed loop. The clock CLK_EXT1 will also be transmitted to a frequency divider 212 via the clock input pin CLK_I, and the frequency divider 212 performs frequency-dividing upon the clock CLK_EXT1 to derive the desired system clock CLK_SYS. Through adjusting a frequency-dividing ratio, the frequency divider 212 can adjust a frequency of the system clock CLK_SYS according to different requirements. The control signal CTRL_EXT is connected to an external supply voltage (or an external ground voltage) to choose the external clock CLK_EXT1 received from the clock input pin CLK_I as the system clock CLK_SYS.

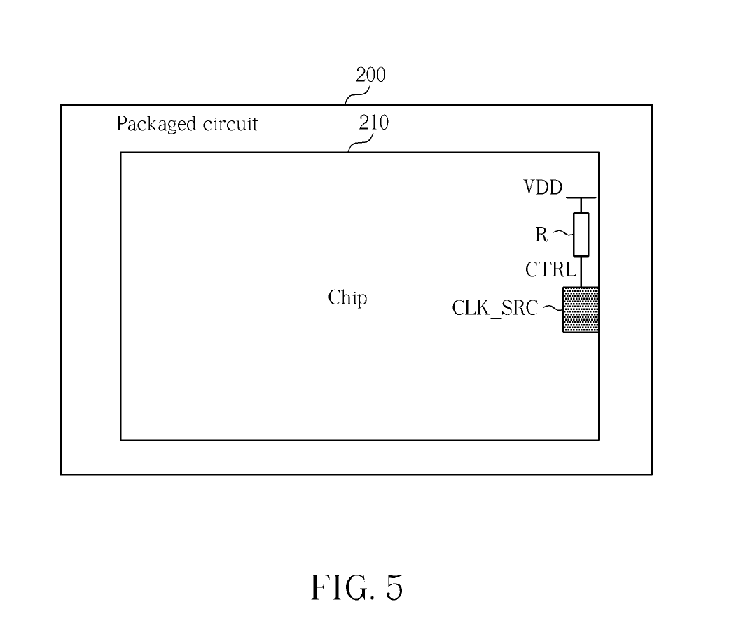

Please note that, in the aforementioned embodiments, the control signal CTRL_EXT is supplied externally via the control pin CLK_CTRL; however, in other embodiments, the control signal CTRL_EXT can also be supplied from an internal signal (e.g., an internal supply voltage or an internal ground voltage) within the chip 210. In this way, a number of pins can be further reduced as well as fabrication costs. By way of example, please refer to FIG. 5, which is a diagram of setting the packaged circuit 200 according to an embodiment of the present invention. For the sake of brevity, partial elements within the packaged circuit 200 are omitted in FIG. 5. Compared with FIG. 2, the control pad CLK_SRC in FIG. 5 is not connected to any pin to receive an external signal, instead, the control pad CLK_SRC is coupled to an internal supply voltage VDD (or an internal ground voltage GND) within the chip 210 via a bias element R (in this example, the bias element R is a resistor). By default, there is no modification for the control pad CTRL_SRC, and the internal supply voltage VDD (or the internal ground voltage GND) will be transmitted to the control pad CLK_SRC to serve as the control signal CTRL via the bias element R; when the control signal CTRL needs to be changed due to different design requirements, it is only required to connect the control pad CLK_SRC to a ground voltage (or a supply voltage) via an electrical connection.

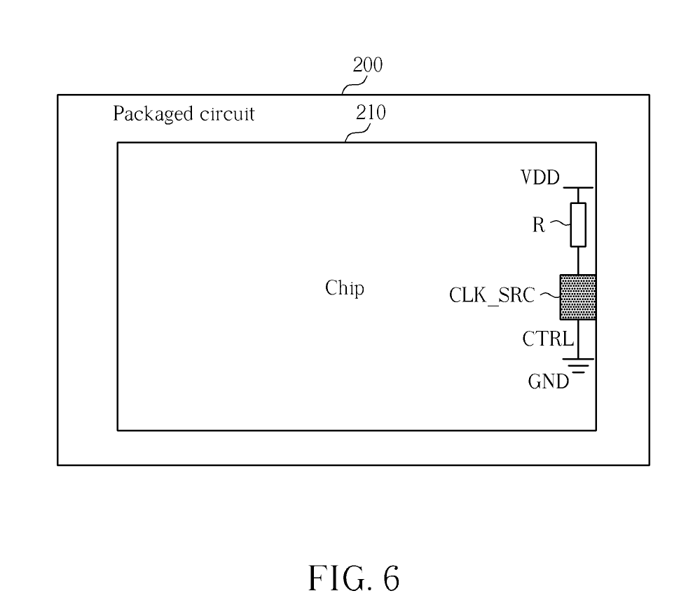

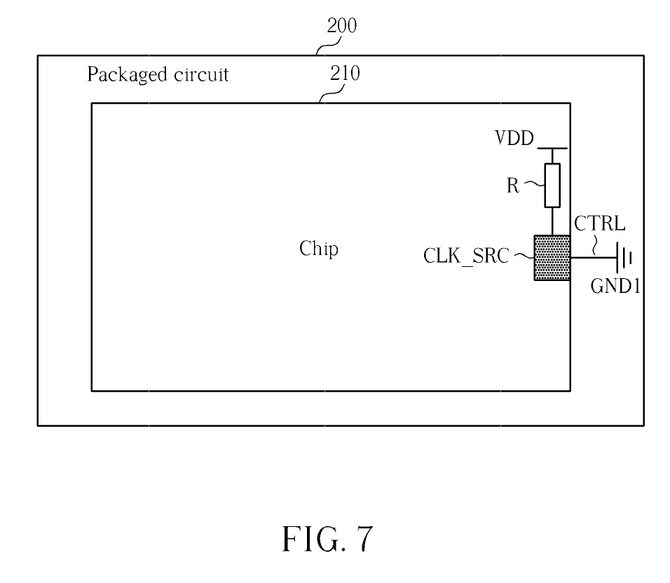

For an illustration of this, please refer to FIG. 6 and FIG. 7. FIG. 6 is a diagram of setting the packaged circuit 200 according to another embodiment of the present invention, and FIG. 7 is a diagram of setting the packaged circuit 200 according to yet another embodiment of the present invention. In FIG. 6, the control pad CLK_SRC is directly connected to an internal ground voltage GND on the chip 210, and the bias element R thereby begins to conduct current and pull a voltage level of the control signal CTRL to a level as the internal ground voltage GND. In this way, the goal of adjusting the system clock CLK_SYS is easily achieved. Likewise, in FIG. 7, the control pad CLK_SRC is directly connected to a packaged ground voltage GND1 (e.g., a ground voltage provided by a lead frame of the packaged circuit 200) in the packaged circuit 200. This also can achieve the same goal of adjusting the system clock CLK_SYS. In addition, the control pad CLK_SRC can also be connected to another ground pad on the chip 210 via a connection line, i.e., the control method of the control pad CLK_SRC can be selected according to different requirements.

To summarize, the present invention provides a packaged circuit with an internal clock. The packaged circuit utilizes multi-function pins, and is capable of measuring and improving (or calibrating) a quality of an internal clock within the packaged circuit easily and quickly, providing the internal clock to other external circuits, and reducing bill of material (BOM) cost. It is also capable of adopting the internal clock or the external clock as a system clock of the packaged clock according to a user's requirement.

Those skilled in the art will readily observe that numerous modifications and alterations of the device and method may be made while retaining the teachings of the invention.

What is claimed is:

1. A packaged circuit, comprising:
an internal circuit;
an embedded clock generator, for generating an internal clock;
a plurality of multi-function pins, comprising:
a clock output pin, for outputting the internal clock generated by the embedded clock generator; and
a clock input pin, for receiving an external clock; and
a control pad, for receiving a control signal to determine whether the internal circuit utilizes a system clock according to the internal clock generated by the embedded clock generator or the external clock received by the clock input pin.

2. The packed circuit of claim 1, wherein the internal circuit calibrates the internal clock generated by the embedded clock generator according to the external clock received from the clock input pin.

3. The packed circuit of claim 1, wherein the clock output pin is directly connected to the clock input pin via an electrical connection.

4. The packed circuit of claim 1, wherein the clock input pin is coupled to an external clock generator, and is for receiving the external clock generated by the external clock generator.

5. The packed circuit of claim 1, further comprising:
a control pin, for receiving an external control signal and outputting the external control signal to the control pad as the control signal.

6. The packed circuit of claim 1, wherein the control signal is an internal supply voltage or an internal ground voltage of the packaged circuit.

7. The packed circuit of claim 6, further comprising:
a bias element, having one terminal coupled to the control pad and the other terminal coupled to the internal supply voltage.

8. The packed circuit of claim 7, wherein the control pad is further coupled to the internal ground voltage.

9. The packed circuit of claim 6, further comprising:
a bias element, having one terminal coupled to the control pad and the other terminal coupled to the internal ground voltage.

10. The packed circuit of claim 9, wherein the control pad is further coupled to the internal supply voltage.

11. The packed circuit of claim 1, further comprising:
a frequency divider, coupled to the clock input pin, for dividing a frequency of the external clock to output the system clock.

12. The packed circuit of claim 1, further comprising:
a resonant element, coupled to the clock output pin and the clock input pin, for providing a resonator for the embedded clock generator.

13. A packaged circuit, comprising:
an internal circuit;
an embedded clock generator, for generating an internal clock; and
a plurality of multi-function pins, comprising:
a clock output pin, for outputting the internal clock generated by the embedded clock generator; and
a clock input pin, for receiving an external clock;
wherein the internal circuit calibrates the internal clock generated by the embedded clock generator according to the external clock received from the clock input pin.

14. A packaged circuit, comprising:
an internal circuit;
an embedded clock generator, for generating an internal clock; and
a plurality of multi-function pins, comprising:
a clock output pin, for outputting the internal clock generated by the embedded clock generator; and
a clock input pin, directly connected to the clock output pin via an electrical connection;
wherein the internal circuit utilizes the internal clock received from the clock input pin as a system clock.

15. A packaged circuit, comprising:
an internal circuit;
an embedded clock generator, for generating an internal clock; and
a plurality of multi-function pins, comprising:
a clock output pin, for outputting the internal clock generated by the embedded clock generator; and
a clock input pin, directly connected to the clock output pin via an electrical connection;
wherein the clock output pin is directly connected to an external circuit via an electrical connection and the internal clock serves as a clock source of the external circuit.
